(19) United States
(12) Patent Application Publication
(10) Pub. No.: US 2026/0211103 A1
(43) Pub. Date: Jul. 23, 2026

(54) METHOD AND DEVICE FOR DETERMINING A RELATIVE POSITION OF RADIO DEVICES

(71) Applicant: Infineon Technologies AG, Neubiberg (DE)

(72) Inventors: Dominic Peter Pirker, Graz (AT); Mathias Gangl, Graz (AT); Christoph Hermann, Graz (AT); Walther Pachler, Graz (AT)

(21) Appl. No.: 19/450,840

(22) Filed: Jan. 16, 2026

(30) Foreign Application Priority Data
Jan. 20, 2025 (DE) 102025101772.7

(51) Int. Cl. G01S 13/76

(52) U.S. Cl. CPC G01S 13/765

(57) ABSTRACT

A method for determining a relative position of radio devices is provided. In one example, a method includes transmitting a ranging initiation signal to first and second responder devices and receiving first and second ranging response signals from the first and second responder devices. A first ranging result signal is received from the first responder device that includes timing information related to a time at which a ranging signal transmitted by the second responder device was received by the first responder device. A second ranging result signal is received from the second responder device that includes timing information related to at time which a ranging signal transmitted by the first responder device was received by the second responder device. Position-related information for the device and the first and second responder devices is determined based on the first and second ranging response signals and the first and second ranging result signals.

### REFERENCE TO RELATED APPLICATION

This application claims the benefit of German Application number 102025101772.7, filed on Jan. 20, 2025, the contents of which are hereby incorporated by reference in their entirety.

### TECHNICAL FIELD

The present disclosure relates to a method and a device for determining a relative position of radio devices.

### BACKGROUND

The main application of UWB (Ultra Wide Band) is based on range measurements. In addition, many use cases also depend on an angle of incidence (AoA: Angle of Arrival (AoA). For example, smart loudspeakers could use the AoA information to beamform an audio signal that follows a user. In addition, access authorization applications often require an angle of a key or person to open a specific door or gain access to specific services in a specific area. Currently, measuring the AoA of a signal requires two or more antennas in order to achieve a usable accuracy, as shown in FIG. 1A:

A TX signal transmitted by a UWB transceiver TX is received by both antennas A and B of a UWB receiver. The additional distance p required by the TX signal to reach antenna B after reaching antenna A is determined (e.g. by means of the additional signal time of flight and/or a phase shift), and the known distance d between the two antennas A and B is used to determine the angle δ therefrom.

Some devices are restricted in size, however, and so it is not possible to accommodate two antennas in them. Often a system consists of more than one device, e.g. smart home or automotive applications. Such a system may, for example, comprise multiple individual UWB transceivers, each of which may have a single antenna.

### BRIEF DESCRIPTION

A method for determining a relative position of radio devices is provided. The method involves: initiating, by means of a first radio device, measurement of respective distances between the first radio device, a second radio device and at least one third radio device; transmitting radio signals at staggered times by means of the first radio device, the second radio device and the third radio device; receiving each of the radio signals transmitted at staggered times by means of the respective other two radio devices; determining a first distance between the first radio device and the second radio device, a second distance between the first radio device and the third radio device and a third distance between the second radio device and the third radio device on the basis of the received radio signals; and determining a first angle of incidence between the first radio device and the second radio device on the basis of the first distance, the second distance and the third distance, the determination of the relative position of the radio devices being based exclusively on the measurement initiated by means of the first radio device, in particular without initiation of additional measurements by means of the second radio device and/or the third radio device.

A system for determining a relative position of radio devices is provided. The system comprises: a first radio device, a second radio device and at least one third radio device, wherein the first radio device is designed for initiating measurement of respective distances between the first radio device, the second radio device and the at least one third radio device, the first radio device, the second radio device and the third radio device transmitting the radio signals at staggered times, for receiving each of the radio signals transmitted at staggered times by means of the respective other two radio devices, for determining a first distance between the first radio device and the second radio device, a second distance between the first radio device and the third radio device and a third distance between the second radio device and the third radio device on the basis of the received radio signals, and for determining a first angle of incidence between the first radio device and the second radio device on the basis of the first distance, the second distance and the third distance, wherein the system is further designed to base the determination of the relative position of the radio devices exclusively on the measurement initiated by means of the first radio device, in particular without initiation of additional measurements by means of the second radio device and/or the third radio device.

A person skilled in the art will discern further features and advantages of the invention upon reading the following detailed description and examining the attached drawings.

### BRIEF DESCRIPTION OF THE DRAWINGS

The present disclosure is shown in an exemplary and non-limiting manner in the illustrations of the attached drawings, in which identical reference numbers refer to similar or identical elements. The elements in the drawings are not necessarily depicted to scale in relation to each other. The features of the various examples shown can be combined, provided that they are not mutually exclusive.

FIG. 1A shows a schematic illustration of determining an angle of incidence for radio devices according to a prior art;

FIG. 1B illustrates a system for determining an angle of incidence;

FIG. 2 illustrates a ranging method according to a prior art;

FIG. 3A schematically illustrates a method according to various exemplary embodiments for determining a relative position of three radio devices;

FIG. 3B schematically illustrates a method according to various exemplary embodiments for determining a relative position of more than three radio devices;

FIG. 4A illustrates a first variant for carrying out a method according to various exemplary embodiments for determining a relative position of at least three radio devices;

FIG. 4B illustrates a second variant for carrying out a method according to various exemplary embodiments for determining a relative position of at least three radio devices;

FIG. 5 schematically illustrates a use case and a system for carrying out a method according to various exemplary embodiments for determining a relative position of at least three radio devices; and

FIG. 6 shows a flowchart of a method according to various exemplary embodiments for determining a relative position of at least three radio devices.

FIG. 7 is a block diagram of a device that determines position-related information based on transmitted and received ranging signals, according to various exemplary embodiments.

### DETAILED DESCRIPTION

In a situation in which radio devices each have only a single antenna, there may be the possibility of using more than two radio devices (UWB devices) for a range measurement method, which is called one-to-many ranging (DS-TWR) and consists of a standardized communication between an initiator and multiple responders.

This allows the initiator to determine its range from all other responders within a range measurement round.

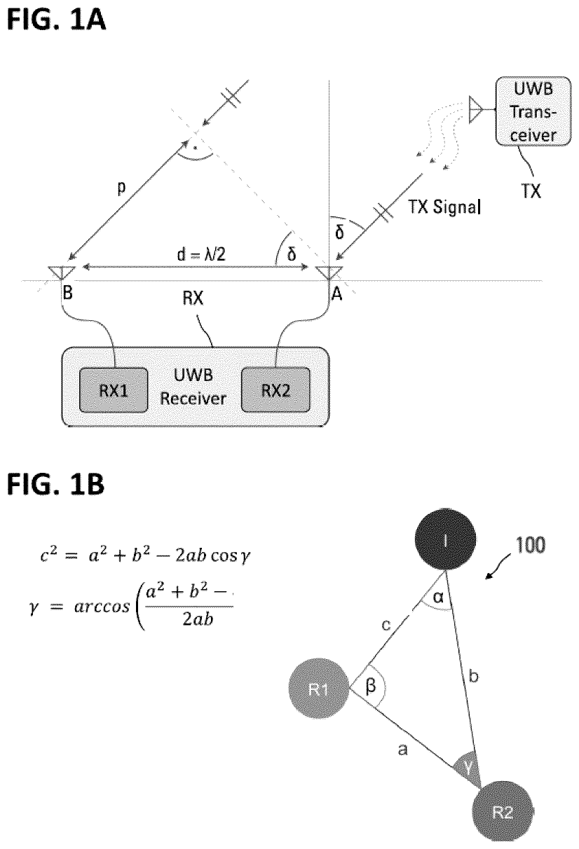

The restriction is that the other devices are not able to measure the ranges from one another. To determine these ranges, a new range measurement round would have to be started in which another device takes over the role of the initiator. FIG. 1B shows an example of the use of DS-TWR (one to many) for a system 100 that has an initiator I (also called a transmitter or transceiver in line with its function) and two responders R1, R2 (also called receivers in line with their function).

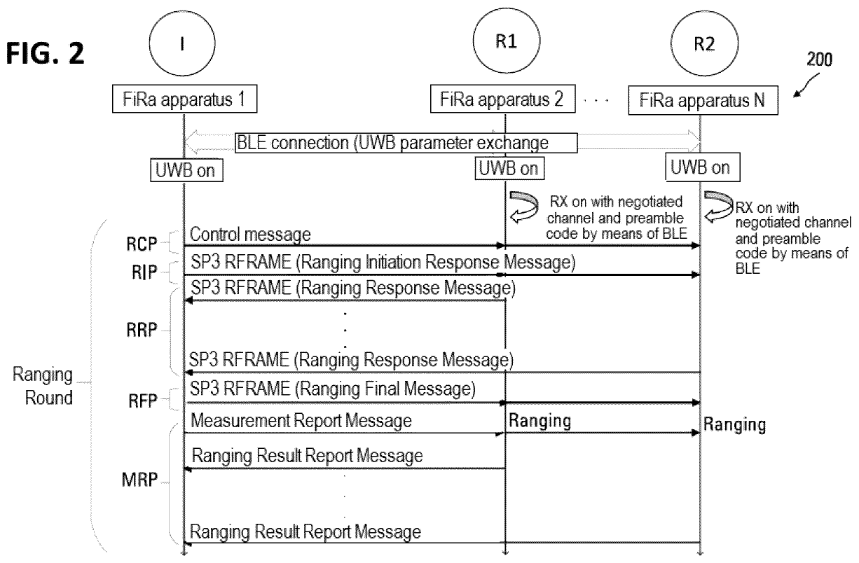

FIG. 2 illustrates a DS-TWR flow in the system 100 comprising the initiator I (device 1) and the responders R1 (device 2) and R2 (device 3), the flow consisting of the following messages:
control messages (CM)—from the initiator
Ranging Initiation Message (RIM)—from the initiator
Ranging Response Message (RRM)—from each responder
Ranging Final Message (RFM)—from the initiator
Measurement Report Message (MRM)—from the initiator.
Ranging Result Report Message (RRRM)—from each responder

This sequence allows the distances b and c from FIG. 1B to be determined.

Distance a between the responder R1 and the responder R2 can be determined by means of a UWB communication between the two responders R1, R2.

According to the prior art, however, this requires one of the responders R1, R2, as initiator, to initiate a new range measurement round (ranging round), which takes place according to the model from FIG. 2, albeit that it is then sufficient for only the one other responder to be addressed.

The three known distances a, b, c can be used to determine the angles α, β and γ of the triangle in a known manner, outlined by way of illustration for the angle γ in the case of the responder R2:

$${c}^{2} = {a}^{2} + {b}^{2} - 2 ab cos γ \qquad ( equation 1 )$$

$$γ = arccos ( \frac{{a}^{2} + {b}^{2} - {c}^{2}}{2 ab} ) \qquad ( equation 2 )$$

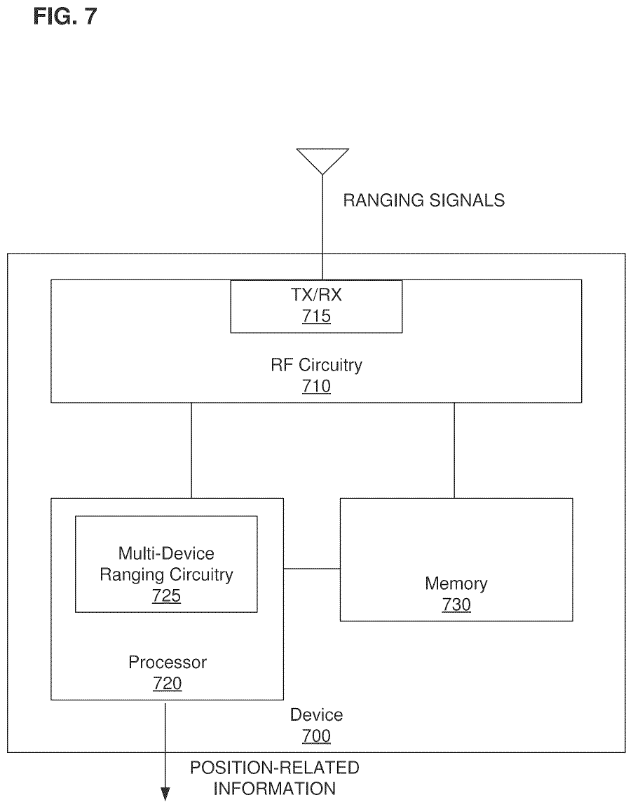

In various exemplary embodiments, a system comprising three or more radio devices (e.g. UWB devices) may be designed to allow all radio devices to determine the ranges to all other radio devices as part of a single range measurement round (ranging round), making it possible to determine the relative position of the other devices and then the angle of the target (which is one of the three or more radio devices or whose position coincides with one of the three or more radio devices). An example of a radio device is illustrated in FIG. 7.

For example, the target may be a person holding a key/smartphone.

This means that three or more radio devices (e.g. UWB devices) can jointly measure the relative position and the angle with respect to the other radio devices.

Each of the radio devices may be formed individually without being formed integrally with one of the other radio devices. For example, each of the radio devices (e.g. the first radio device, the second radio device and the at least one third radio device) may have its own housing and/or at least its own carrier. See FIG. 7 for an exemplary radio device. In other embodiments, one or more of the radio devices may be integrated in the same device.

Each of the radio devices may be freely- and thus substantially arbitrarily-positionable relative to any other of the radio devices.

The embodiments described here allow participating radio devices in a UWB session to measure a range to other participating radio devices within a single range measurement round (ranging round) without having to change their role as initiator or responder and perform additional range measurement sessions. In this way, a system consisting of three or more radio devices can calculate the relative positions of the radio devices and jointly, for example by means of a cooperative measurement, determine an angle of incidence (AoA) of a target, in particular a radio device that for spatial or technical reasons is limited to a single receiver path (a single antenna).

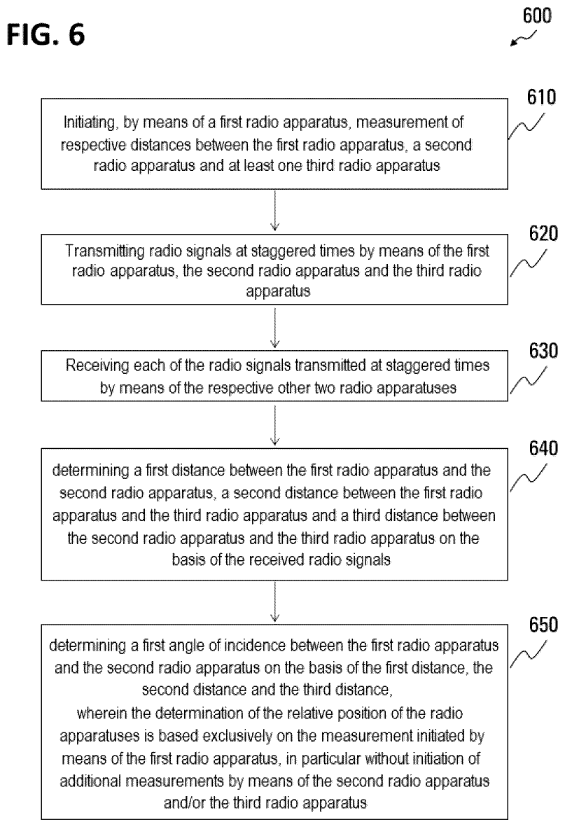

FIG. 6 shows a flowchart 600 for a method according to various exemplary embodiments for determining a relative position of at least three radio devices I, R1, R2, . . . RN.

The system 100 shown in FIG. 1B shows the radio devices I, R1 and R2 involved and the illustrative relative arrangement thereof merely schematically.

The description that follows refers, unless indicated otherwise, to the system 100 and the radio devices I, R1, R2, . . . , RN according to various exemplary embodiments.

The radio devices I, R1, R2, . . . , RN may be designed for UWB communication, for example in a frequency range from approximately 3.1 to approximately 10.6 GHz, for example in accordance with an extended UWB standard, e.g. according to an extension of the standard developed by the FiRa (Fine Ranging) consortium. For example, the FiRa standard may be extended by an additional SP configuration. The additional SP configuration may be designed to allow additional transmission of total times of flight and response times.

Each of the radio devices I, R1, R2, . . . , RN has only one receiving channel (a receiving antenna) (instead of two or more receiving channels/receiving antennas, as is often provided in the prior art when an angle of incidence is intended to be determined).

The method involves: initiating, by means of a first radio device I, measurement of respective distances between the first radio device I, a second radio device R1 and at least one third radio device R2, . . . , RN (610).

“At least one third radio device R2, . . . , RN” is intended to be understood herein such that at least the third radio device R2 is provided for the method or as part of the system 100, but in addition a fourth radio device R3, a fifth radio device R4, through to an N+1-th radio device RN may also be provided, which are used to carry out the method.

The first radio device I has the role of the initiator and initiates a respective distance measurement (which is called ranging in the FiRa standard) to the at least two other radio devices R1, R2, . . . , RN, each of which is in the role of a responder.

The initiation itself can involve causing an order of the radio devices I, R1, R2, . . . , RN to be defined, which order is taken into account in the subsequent radio communication (UWB communication).

The method further involves transmitting radio signals at staggered times by means of the first radio device I, the second radio device R1 and the at least one third radio device R2, . . . , RN (620).

The transmission at staggered times may be designed so that at least one first transmission by each of the radio devices I, R1, R2, . . . , RN is carried out with a time stagger according to the order (e.g. defined during initiation).

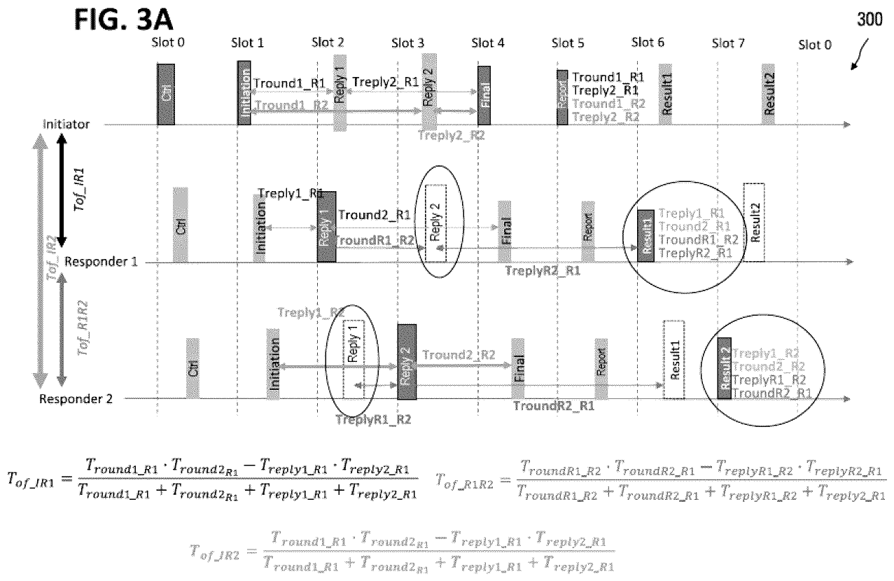

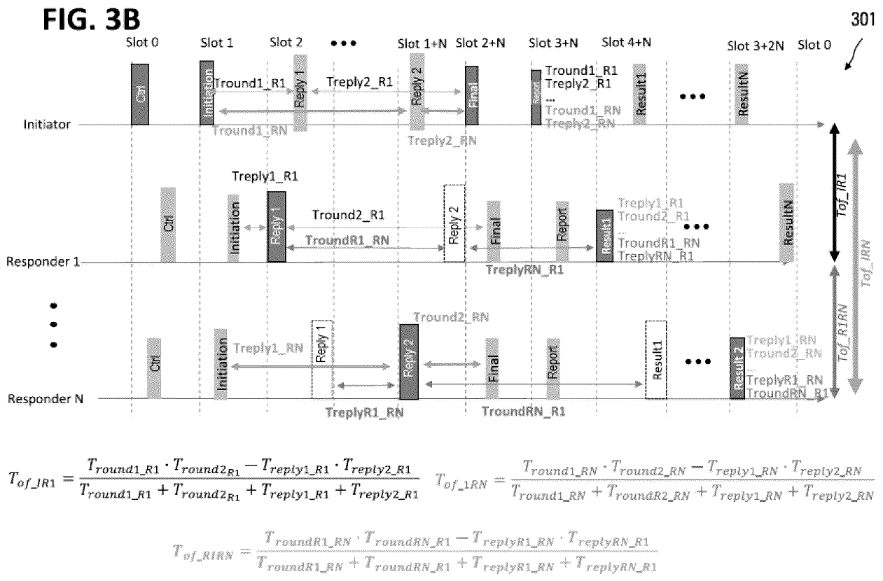

In various exemplary embodiments, the transmission at staggered times can take place within successive synchronized transmission time windows. This and other aspects of the exemplary embodiments are explained illustratively below with reference to FIGS. 3A and 3B.

The method further involves receiving each of the radio signals transmitted at staggered times by means of the respective other at least two radio devices (630).

The method further involves determining a first distance c between the first radio device I and the second radio device R1, a second distance b between the first radio device I and the third radio device R2 and a third distance a between the second radio device R1 and the third radio device R2 on the basis of the received radio signals (640).

If the at least one third radio device has a fourth, fifth, . . . . N-th radio device, additional distances between the radio devices I, R1, R2, . . . , RN can further be determined, specifically in such a way that a distance between the first radio device I and each of the fourth, fifth, . . . . N-th radio devices is additionally determined in each case, and additionally at least in such a way that the radio devices I, R1, R2, . . . , RN are connected in a chain-like manner by determined distances. “Chain-like connection”, given a clear description, is intended to be understood to mean that extending FIG. 1B by a fourth radio device R3, for example to the right of the connecting line representing the distance b, results in the distance of the fourth radio device R3 from the first radio device I and from the third radio device R2 being determined. This means that there would in turn be a triangle I-R2-R3 of determined distances that allows all angles to be determined. It would not be necessary to determine the distance between the second radio device R1 and the fourth radio device R3 (which would essentially be a further diagonal of the square), but this can be done according to various exemplary embodiments, for example for additional calculations to increase the accuracy of position determination.

The method further involves determining a first angle of incidence between the first radio device I and the second radio device R1 on the basis of the first distance c, the second distance a and the third distance b. Optionally, additional angles of incidence can also be determined, for example between the first radio device I and the third radio device R2 and/or between the second radio device R1 and the third radio device R2.

The method involves the determination of the relative position of the radio devices I, R1, R2, . . . , RN being based exclusively on the measurement initiated by means of the first radio device I, in particular without initiation of additional measurements by means of the second radio device R1 and/or the third radio device R2 (650).

This is intended to be understood to mean that the complete distance determination for the radio devices I, R1, R2, . . . , RN of the system 100 is carried out within a single ranging round, i.e. without one or more of the radio devices I, R1, R2, . . . , RN having to change their role (from initiator to responder or vice versa).

Details regarding the transmission of radio signals at staggered times and regarding reception of the radio signals are explained with reference to FIG. 3A, which schematically illustrates a method according to various exemplary embodiments for determining a relative position of three radio devices. FIG. 3B schematically illustrates a corresponding more general method according to various exemplary embodiments for determining a relative position of more than three radio devices.

The radio signals in slot 0 that are marked Ctrl in FIG. 3A are control signals that, for example, initiate the ranging round, define the roles of the initiator (which transmits the control signal Ctrl) and the responders R1 and R2 and also define an order of the responders (in this illustrative case, the second radio device R1 is supposed to respond first, then the third radio device R2).

The transmission of radio signals at staggered times involves transmitting a first radio signal (in slot 1, marked Initiation) by means of the first radio device I, and, after reception of the first radio signal in the second radio device R1 and in the third radio device R2 (in each case also marked Initiation there with a gray background), transmitting a second radio signal (in slot 2, marked Reply 1) by means of the second radio device R1 and then transmitting a third radio signal (in slot 3, marked Reply 2) by means of the third radio device R2.

Between the transmission of the second radio signal by means of the second radio device R1 and the transmission of the third radio signal by means of the third radio device R2, the second radio signal can be received in the third radio device R2. Receiving a signal from a radio device in a ranging round (in particular in a way that allows further processing of the received signal) is prevented in the prior art. Therefore, this process is highlighted with an ellipse in FIG. 3A—and also the other new processes in the method according to various exemplary embodiments, such as receiving Reply 2 in the first radio device and transmitting response times and total times of flight by means of the second radio device R1 and the third radio device R2.

In the method according to various exemplary embodiments, the transmission of radio signals at staggered times can involve transmitting response times and total times of flight at least from the second radio device R1 to the first radio device I and from the third radio device R2 to the first radio device R1. Optionally, additional response times and total times of flight can also be transmitted between the radio devices I, R1, R2, RN.

A response time is intended to be understood to mean a period of time between reception of a radio signal and transmission of a radio signal in response to the received radio signal in one of the radio devices, and a total time of flight is intended to be understood to mean a period of time between transmission of one radio signal and reception of another radio signal in one of the radio devices I, R1, R2, . . . , RN, the other radio signal having been transmitted by another of the radio devices I, R1, R2, . . . , RN in response to the radio signal transmitted by the radio device.

The transmission of radio signals at staggered times can further involve transmitting response times and total times of flight from the second radio device R1 to the third radio device R2 and/or from the first radio device I to the second radio device R1 and/or the third radio device R2.

Response times and total times of flight are illustrated in FIGS. 3A and 3B, and also which response times and total times of flight are transmitted (in FIG. 3A, for example, in slot 5 from the first radio device I to the second and third radio devices R1, R2, from the second radio device R1 in slot 6 to the first radio device I and the second radio device R3, and in slot 7 from the second radio device R2 to the first radio device I and the second radio device R1. All radio devices I, R1, R2, . . . , RN can then optionally have all response times and total times of flight and even perform all necessary calculations regarding distances and angles of incidence, etc.

A total time of flight T_{of_IR1} can be used to determine the distance c between the first radio device I and the second radio device R1 by means of the signal speed (approximately the speed of light).

Similarly, a total time of flight T_{of_IR2} can be used to determine the distance a between the first radio device I and the third radio device R2.

Similarly, a total time of flight T_{of_R1R2} can be used to determine the distance b between the second radio device R1 and the third radio device R2.

For the case of the three radio devices I, R1, R2, the total times of flight can be calculated as follows:

$${T}_{of\_IR 1} = \frac{{T}_{round 1 \_ R 1} \cdot {T}_{round {2}_{R 1}} - {T}_{reply 1 \_ R 1} \cdot {T}_{reply 2 \_ R 1}}{{T}_{round 1 \_ R 1} + {T}_{round {2}_{R 1}} + {T}_{reply 1 \_ R 1} + {T}_{reply 2 \_ R 1}}$$

$${T}_{of\_R 1 R 2} = \frac{{T}_{roundR 1 \_ R 2} \cdot {T}_{roundR 2 \_ R 1} - {T}_{replyR 1 \_ R 2} \cdot {T}_{replyR 2 \_ R 1}}{{T}_{roundR 1 \_ R 2} + {T}_{roundR 2 \_ R 1} + {T}_{replyR 1 \_ R 2} + {T}_{reply 2 \_ R 1}}$$

$${T}_{of\_IR 2} = \frac{{T}_{round 1 \_ R 1} \cdot {T}_{round {2}_{R 1}} - {T}_{reply 1 \_ R 1} \cdot {T}_{reply 2 \_ R 1}}{{T}_{round 1 \_ R 1} + {T}_{round {2}_{R 1}} + {T}_{reply 1 \_ R 1} + {T}_{reply 2 \_ R 1}}$$

The angle of incidence can be determined by means of equations 1 and 2.

The corresponding equations for the general case of N+1 radio devices I, R1, R2, . . . , N are:

$${T}_{of\_IR 1} = \frac{{T}_{round 1 \_ R 1} \cdot {T}_{round {2}_{R 1}} - {T}_{reply 1 \_ R 1} \cdot {T}_{reply 2 \_ R 1}}{{T}_{round 1 \_ R 1} + {T}_{round {2}_{R 1}} + {T}_{reply 1 \_ R 1} + {T}_{reply 2 \_ R 1}}$$

$${T}_{of\_ 1 RN} = \frac{{T}_{round 1 \_ RN} \cdot {T}_{round 2 \_ RN} - {T}_{reply 1 \_ RN} \cdot {T}_{reply 2 \_ RN}}{{T}_{round 1 \_ RN} + {T}_{roundR 2 \_ RN} + {T}_{reply 1 \_ RN} + {T}_{reply 2 \_ RN}}$$

$${T}_{of\_RIRN} = \frac{{T}_{roundR 1\_ RN} \cdot {T}_{roundRN \_ R 1} - {T}_{replyR 1 \_ RN} \cdot {T}_{replyRN \_ R 1}}{{T}_{roundR 1 \_ RN} + {T}_{roundRN \_ R 1} + {T}_{replyR 1 \_ RN} + {T}_{replyRN \_ R 1}}$$

Here too, the angle(s) of incidence is/are determined using accordingly modified equations 1 and 2.

As already mentioned above, it may be necessary to extend the FiRa standard to permit the above described transmission, reception and evaluation of the signals according to various exemplary embodiments. Accordingly, the radio devices I, R1, R2, . . . , RN must be designed to implement this extended FiRa standard.

In order to be able to perform valid and safe distance measurements, the third radio device R2 (the second responder) must intercept the Ranging Response Message of the second radio device R1 (the first responder) (and vice versa). This is illustrated in FIG. 3A by means of the two left-hand ellipses.

For example, the standard can be extended by means of one of the following two variants:

According to variant a), an addition to the PHY layer and a very small change to the MAC layer (Media Access Control layer) can be made.

For example, a Ranging Result Report Message (RRRM) format can be changed from an SP0 packet to an SP1, SP3 or SP2 packet that has a payload and the STS (Scrambled Timestamp Sequence, relevant to ensuring that communication takes place only between authorized parties). This may be necessary in order to add the measured round and reply times and transmit them to the other devices in the distance measurement.

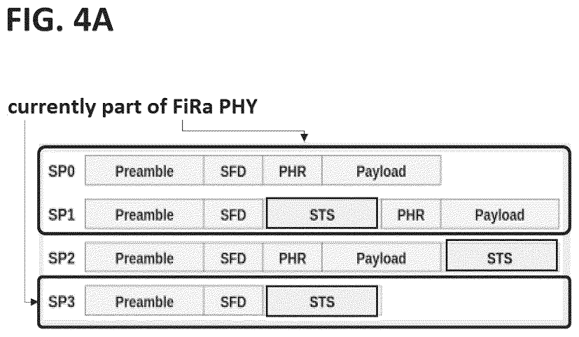

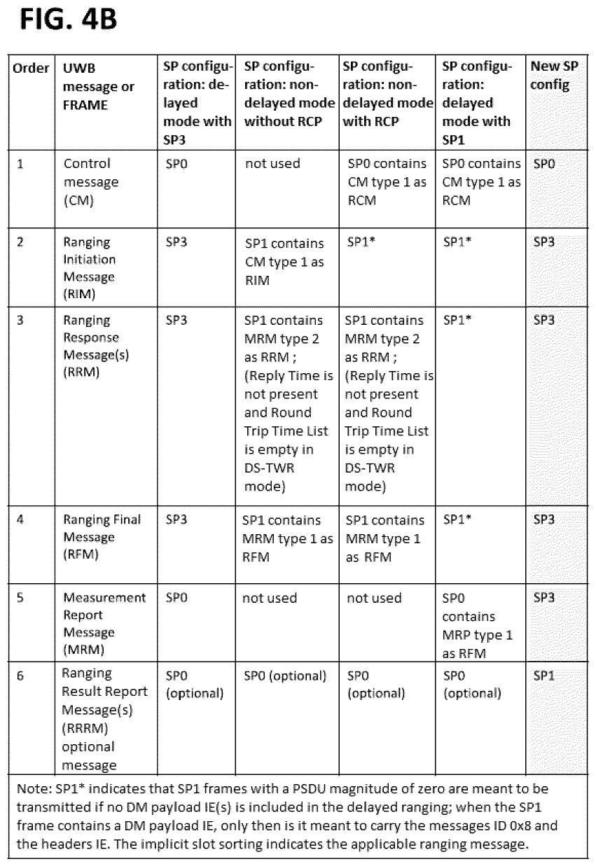

The addition to the PHY layer can include addition of the Physical Layer Protocol Data Unit (PPDU) format SP2, which is currently not part of FiRa. FIG. 4A shows a corresponding illustration, in particular the differences between the SP0, SP1 and SP3 already included in FiRa PHY and the newly added SP2.

The very small change to the MAC layer may mean that SP2 is added as an option for SP configuration of the RRRM in Table 52 of the FiRa standard. This allows t_round and t_reply to be added as payload when transmitting the RRRM.

In the case of variant b), the change to the PHY layer can be dispensed with, as the SP3 mode can be used, which is currently already part of the PHY layer according to the FiRa standard. However, the change to the MAC layer may be slightly larger:

Table 52 of the FiRa standard can be extended by a column that adds an SP configuration, e.g. a “delayed mode with SP3 and a secure RRRM”.

This is shown by way of illustration in FIG. 4B: According to the new SP configuration (column highlighted in light gray), the RRRM is transmitted according to SP1, which allows t_round and t_reply to be transmitted as payload when transmitting the RRRM.

These changes to the prior art make it possible to measure the ranges between the responders and thus calculate a relative position and the target angle jointly (CAoT) within a range measurement round.

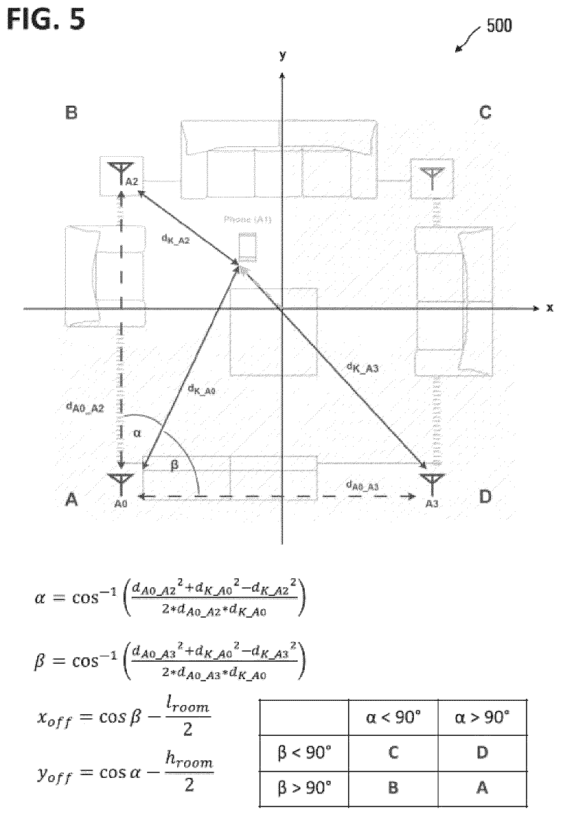

FIG. 7 is a block diagram of an example device 700 that is configured to determine position-related information with respect to multiple devices in the same ranging round. The device 700 may serve as the initiator device or a responder device in any of the example systems of FIGS. 1-6. The device 700 includes RF circuitry 710 having a transmitter/receiver TX/RX 715. The TX/RX 715 is configured to receive ranging signals from other devices in a positioning system (e.g., system 100). The ranging signals broadly refer to any signals that are exchanged in a ranging operation in which a device determines position-related information for the device or another device in the system. Ranging signals may include a ranging configuration signal, a ranging initiation signal, a ranging response signal, a ranging result signal, and so on. Position-related information broadly refers to any information that may be deduced from the timing of transmission and reception of the ranging messages, such as, for example, time of arrival, round-trip time, angle of arrival, relative positions of the devices in the system, and so on.

The device 700 includes a processor 720 and memory 730. The processor is configured to process baseband or other digital signals derived from received ranging signals and to generate baseband or other digital signals that are provided to the RF circuitry 710 for transmission by TX/RX 715. The processor 720 may store or retrieve the baseband or other digital signals in the memory 730. The processor 720 may execute instructions stored in the memory 730 to perform any of the methods or algorithms described above.

The processor includes multi-device ranging circuitry 725 that is configured to receive ranging signals that include information used to perform multi-device ranging as described above. Multi-device ranging includes, in one example, a technique in which responder devices receive, in addition to ranging signals from the initiator, ranging signals from another responder device and provide timing-related information for the ranging signals from the other responder device to the initiator device (e.g., in an “extended” ranging result signal”). The initiator device is thus able to determine its position with respect to the multiple responder devices in the same ranging round and the responder devices are not tasked with performing ranging with respect to each other in another ranging round.

In the present disclosure like reference numerals are used to refer to like elements throughout, and wherein the illustrated structures and devices are not necessarily drawn to scale. As utilized herein, terms “module”, “component,” “system,” “circuit,” “circuitry,” “element,” “slice,” and the like are intended to refer to a computer-related entity, hardware, software (e.g., in execution), and/or firmware. For example, circuitry or a similar term can be a processor, a process running on a processor, a controller, an object, an executable program, a storage device, and/or a computer with a processing device. By way of illustration, an application running on a server and the server can also be circuitry. One or more circuitries can reside within a process, and circuitry can be localized on one computer and/or distributed between two or more computers. A set of elements or a set of other circuitry can be described herein, in which the term “set” can be interpreted as “one or more.”

As another example, circuitry or similar term can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, circuitry can be an apparatus that provides specific functionality through electronic components without mechanical parts; the electronic components can include field gates, logical components, hardware encoded logic, register transfer logic, one or more processors therein to execute software and/or firmware that confer(s), at least in part, the functionality of the electronic components.

Use of the word exemplary is intended to present concepts in a concrete fashion. The terminology used herein is for the purpose of describing particular examples only and is not intended to be limiting of examples. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof. As used herein the term “or” includes the option of all elements related by the word or. For example A or B is to be construed as include only A, only B, and both A and B. Further the phrase “one or more of” followed by A, B, or C is to be construed as including A, B, C, AB, AC, BC, and ABC.

There follows a summary of a few exemplary embodiments.

Exemplary embodiment 1 is a method for determining a relative position of radio devices. The method involves: initiating, by means of a first radio device, measurement of respective distances between the first radio device, a second radio device and at least one third radio device; transmitting radio signals at staggered times by means of the first radio device, the second radio device and the at least one third radio device; receiving each of the radio signals transmitted at staggered times by means of the respective other at least two radio devices; determining a first distance between the first radio device and the second radio device, a second distance between the first radio device and the third radio device and a third distance between the second radio device and the third radio device on the basis of the received radio signals; and determining a first angle of incidence between the first radio device and the second radio device on the basis of the first distance, the second distance and the third distance, the determination of the relative position of the radio devices being based exclusively on the measurement initiated by means of the first radio device, in particular without initiation of additional measurements by means of the second radio device and/or the third radio device.

Exemplary embodiment 2 is a method according to exemplary embodiment 1, wherein the initiation involves causing an order of the radio devices to be defined.

Exemplary embodiment 3 is a method according to exemplary embodiment 2, wherein the transmission of radio signals at staggered times involves at least one respective first transmission by the radio devices taking place according to the order.

Exemplary embodiment 4 is a method according to one of exemplary embodiments 1 to 3, wherein the transmission at staggered times takes place within successive synchronized transmission time windows.

Exemplary embodiment 5 is a method according to one of exemplary embodiments 1 to 4, wherein the transmission of radio signals at staggered times involves transmitting a first radio signal by means of the first radio device, and, after reception of the first radio signal in the second radio device and in the third radio device, transmitting a second radio signal by means of the second radio device and then transmitting a third radio signal by means of the third radio device.

Exemplary embodiment 6 is a method according to exemplary embodiment 5, which further involves receiving the second radio signal in the third radio device between the transmission of the second radio signal by means of the second radio device and the transmission of the third radio signal by means of the third radio device.

Exemplary embodiment 7 is a method according to one of exemplary embodiments 1 to 6, wherein the transmission of radio signals at staggered times involves transmitting response times and total times of flight at least from the second radio device to the first radio device and from the third radio device to the first radio device, a response time being a period of time between reception of a radio signal and transmission of a radio signal in response to the received radio signal in one of the radio devices, and a total time of flight being a period of time between transmission of one radio signal and reception of another radio signal in one of the radio devices, the other radio signal having been transmitted by another of the radio devices in response to the radio signal transmitted by the radio device.

Exemplary embodiment 8 is a method according to exemplary embodiment 7, wherein the transmission of radio signals at staggered times further involves transmitting response times and total times of flight from the second radio device to the third radio device and/or from the first radio device to the second radio device and/or the third radio device.

Exemplary embodiment 9 is a method according to one of exemplary embodiments 1 to 8, which further involves determining a second angle of incidence between the first radio device and the third radio device and/or a third angle of incidence between the second radio device and the third radio device on the basis of the first distance, the second distance and the third distance.

Exemplary embodiment 10 is a method according to one of exemplary embodiments 1 to 9, wherein the radio signals are UWB radio signals.

Exemplary embodiment 11 is a method according to one of exemplary embodiments 1 to 10, based on an extended FiRa standard.

Exemplary embodiment 12 is a method according to exemplary embodiment 11, wherein the FiRa standard is extended by an additional SP configuration.

Exemplary embodiment 13 is a method according to exemplary embodiment 12, wherein the additional SP configuration is designed to allow additional transmission of total times of flight and response times.

Exemplary embodiment 14 is a device for determining a relative position of radio devices. The device comprises: a first radio device, a second radio device and at least one third radio device, wherein the first radio device is designed for initiating measurement of respective distances between the first radio device, the second radio device and the at least one third radio device, the first radio device, the second radio device and the third radio device transmitting the radio signals at staggered times, for receiving each of the radio signals transmitted at staggered times by means of the respective other at least two radio devices, for determining a first distance between the first radio device and the second radio device, a second distance between the first radio device and the third radio device and a third distance between the second radio device and the third radio device on the basis of the received radio signals, and for determining a first angle of incidence between the first radio device and the second radio device on the basis of the first distance, the second distance and the third distance, wherein the device is further designed to base the determination of the relative position of the radio devices exclusively on the measurement initiated by means of the first radio device, in particular without initiation of additional measurements by means of the second radio device and/or the third radio device.

Exemplary embodiment 15 is a device according to exemplary embodiment 14, wherein the initiation involves causing an order of the radio devices to be defined.

Exemplary embodiment 16 is a device according to exemplary embodiment 15, wherein the transmission of radio signals at staggered times involves at least one respective first transmission by the radio devices taking place according to the order.

Exemplary embodiment 17 is a device according to one of exemplary embodiments 1 to 16, wherein the transmission at staggered times takes place within successive synchronized transmission time windows.

Exemplary embodiment 18 is a device according to one of exemplary embodiments 14 to 17, wherein the transmission of radio signals at staggered times involves transmitting a first radio signal by means of the first radio device, and, after reception of the first radio signal in the second radio device and in the third radio device, transmitting a second radio signal by means of the second radio device and then transmitting a third radio signal by means of the third radio device.

Exemplary embodiment 19 is a device according to exemplary embodiment 18, wherein the second radio device is further designed for receiving the second radio signal in the third radio device between the transmission of the second radio signal and the transmission of the third radio signal by means of the third radio device.

Exemplary embodiment 20 is a device according to one of exemplary embodiments 14 to 17, wherein the transmission of radio signals at staggered times involves transmitting response times and total times of flight at least from the second radio device to the first radio device and from the third radio device to the first radio device,
a response time being a period of time between reception of a radio signal and transmission of a radio signal in response to the received radio signal in one of the radio devices, and a total time of flight being a period of time between transmission of one radio signal and reception of another radio signal in one of the radio devices, the other radio signal having been transmitted by another of the radio devices in response to the radio signal transmitted by the radio device.

Exemplary embodiment 21 is a device according to exemplary embodiment 20, wherein the transmission of radio signals at staggered times further involves transmitting response times and total times of flight from the second radio device to the third radio device and/or from the first radio device to the second radio device and/or the third radio device.

Exemplary embodiment 22 is a device according to one of exemplary embodiments 14 to 21, further involving determining a second angle of incidence between the first radio device and the third radio device and/or a third angle of incidence between the second radio device and the third radio device on the basis of the first distance, the second distance and the third distance.

Exemplary embodiment 23 is a device according to one of exemplary embodiments 14 to 22, wherein the radio signals are UWB radio signals.

Exemplary embodiment 24 is a device according to one of exemplary embodiments 14 to 21, which is designed for transmitting and receiving the radio signals on the basis of an extended FiRa standard.

Exemplary embodiment 25 is a device according to exemplary embodiment 24, wherein the FiRa standard is extended by an additional SP configuration.

Exemplary embodiment 26 is a device according to exemplary embodiment 25, wherein the additional SP configuration is designed to allow additional transmission of total times of flight and response times.

Further advantageous configurations of the device are evident from the description of the method, and vice versa.

It should be pointed out that the description and the drawings only illustrate the principles of the proposed methods and devices. A person skilled in the art will be capable of implementing different arrangements which, although they are not expressly described or shown here, embody the principles of the invention and are contained within the scope thereof. In addition, all examples and embodiments outlined in the present document are intended fundamentally and expressly for explanatory purposes only, in order to help the reader understand the principles of the proposed methods and devices. In addition, all statements in this document that describe principles, aspects and embodiments of the invention and specific examples thereof are also intended to encompass their equivalents.

What is claimed is:

1. A system for determining a relative position of radio devices, the system comprising:
a first radio device, a second radio device and at least one third radio device;
wherein the first radio device is designed for initiating measurement of respective distances between the first radio device, the second radio device and the at least one third radio device;
wherein the first radio device, the second radio device and the third radio device are configured to transmit the radio signals at staggered times;
wherein each of the first radio device, the second radio device and the third radio device is configured to receive each of the radio signals transmitted at staggered times by means of respective other at least two radio devices;
wherein the first radio device is configured to
determine a first distance between the first radio device and the second radio device, a second distance between the first radio device and the third radio device and a third distance between the second radio device and the third radio device on the basis of the received radio signals; and
determine a first angle of incidence between the first radio device and the second radio device on the basis of the first distance, the second distance and the third distance,
further wherein the device is further designed to base the determination of the relative position of the radio devices exclusively on the measurement initiated by means of the first radio device, in particular without initiation of additional measurements by means of the second radio device or the third radio device.

2. The device of claim 1, wherein the initiation comprises defining an order according to which respective first transmissions by the radio devices occurs.

3. The device of claim 1, wherein the transmission at staggered times takes place within successive synchronized transmission time windows.

4. The device of claim 1, wherein the transmission of radio signals at staggered times comprises transmitting a first radio signal by means of the first radio device, and, after reception of the first radio signal in the second radio device and in the third radio device, transmitting a second radio signal by means of the second radio device and then transmitting a third radio signal by means of the third radio device.

5. The device of claim 4, wherein the third radio device is configured to receive the second radio signal between the transmission of the second radio signal and the transmission of the third radio signal by means of the third radio device.

6. The device of claim 1,
wherein the transmission of radio signals at staggered times comprises transmitting response times and total times of flight at least from the second radio device to the first radio device and from the third radio device to the first radio device,
a response time being a period of time between reception of a radio signal and transmission of a radio signal in response to the received radio signal in one of the radio devices, and
a total time of flight being a period of time between transmission of one radio signal and reception of another radio signal in one of the radio devices, the other radio signal having been transmitted by another of the radio devices in response to the radio signal transmitted by the radio device.

7. The device of claim 6, wherein the transmission of radio signals at staggered times further comprises transmitting response times and total times of flight from the second radio device to the third radio device or from the first radio device to the second radio device or the third radio device.

8. The device of claim 6, configured to determine a second angle of incidence between the first radio device and the third radio device or a third angle of incidence between the second radio device and the third radio device on the basis of the first distance, the second distance and the third distance.

9. The device of claim 1, wherein the radio signals are UWB radio signals.

10. The device of claim 1, configured to transmit and receive radio signals on the basis of an extended FiRa standard.

11. The device of claim 10, wherein the FiRa standard is extended by an additional SP configuration.

12. The device of claim 11, wherein the additional SP configuration is designed to allow additional transmission of total times of flight and response times.

13. The device of claim 1, wherein each of the radio devices is freely positionable relative to any other of the radio devices.

14. A device comprising
a transmitter configured to transmit a ranging initiation signal to a first responder device and a second responder device;
a receiver configured to, responsive to the ranging initiation signal,
receive a first ranging response signal from the first responder device;
receive a second ranging response signal from the second responder device;
receive a first ranging result signal from the first responder device, wherein the first ranging result signal includes timing information related to a time at which a ranging signal transmitted by the second responder device was received by the first responder device; and
receive a second ranging result signal from the second responder device, wherein the second ranging result signal includes timing information related to at time which a ranging signal transmitted by the first responder device was received by the second responder device; and
multi-device ranging circuitry, configured to determine position-related information for the device, the first responder device, and the second responder device based on the first and second ranging response signals and the first and second ranging result signals.

15. The device of claim 14, wherein
the first ranging result signal includes an indication of a difference between a time at which the first responder device transmitted the first ranging response signal and a time at which the first responder device received the second ranging response signal; and
the second ranging result signal includes an indication of a difference between a time at which the second responder device transmitted the second ranging response signal and a time at which the second responder device received the first ranging result signal.

16. The device of claim 14, wherein
the first ranging result signal includes an indication of a difference between a time at which the first responder device received the second ranging response signal and a time at which the first responder device transmitted the first ranging result signal; and
the second ranging result signal includes an indication of a difference between a time at which the second responder device received the first ranging response signal and a time at which the second responder device transmitted the second ranging response signal.

17. The device of claim 14, wherein the first and second ranging result signals comprise UWB signals configured according to an extended FiRa standard that includes an addition SP configuration that supports additional transmission of total times of flight or response times.

18. A device, comprising
a receiver configured to
receive a ranging initiation signal from an initiator device, wherein the ranging initiation signal initiates a ranging process between the initiator device and two responder devices, wherein the two responder devices include the device and an other responder device; and
receive a ranging signal from the other responder device, wherein the ranging signal is responsive to the ranging initiation signal;
multi-device ranging circuitry configured to, responsive to the ranging initiation signal, generate a first ranging result signal based on the ranging signal from the other responder device;
a transmitter configured to
transmit a first ranging response signal to the initiator device; and
transmit the first ranging result signal to the initiator device, wherein the first ranging result signal includes timing information related to a time at which a ranging signal transmitted by the other responder device was received by the device.

19. The device of claim 18, wherein the first ranging result signal includes an indication of a difference between a time at which the device transmitted the first ranging response signal and a time at which the device received a second ranging response signal transmitted by the other responder device.

20. The device of claim 18, wherein the first ranging result signal includes an indication of a difference between a time at which the device received a second ranging response signal transmitted by the other responder device and a time at which the device transmitted the first ranging result signal.
